(19) United States
(12) Patent Application Publication
(10) Pub. No.: US 2003/0236042 A1
(43) Pub. Date: Dec. 25, 2003

(54) Method of making far infrared polymers and the products thereof

(76) Inventor: Chi-Lien Ko, Taichung (TW)

Correspondence Address: VARNDELL & VARNDELL, PLLC, 106-A S. COLUMBUS ST., ALEXANDRIA, VA, 22314, US

(21) Appl. No.: 10/175,826

(22) Filed: Jun. 21, 2002

(51) Int. Cl. B32B 3/00; B32B 5/02; B32B 9/00; B32B 27/04; B32B 27/12; D03D 15/00; D03D 25/00

(52) U.S. Cl. 442/59; 442/131

(57) ABSTRACT

A method for making a far infrared polymer that uses far infrared mineral powder in a proper amount to mix with resin to become usable and endurable products such as far infrared membrane, coating or glue. These products are further applied to objects to make the objects have far infrared features and other beneficial physical properties.

### BACKGROUND OF THE INVENTION

1. Field of the Invention

The present invention relates to methods of making far infrared polymers, and more particularly to methods of making far infrared polymers to produce laminated cloth wherein the laminated cloth has excellent waterproof, windproof, warmth holding and damp-proof features. This invention also relates to other relevant products.

2. Description of Related Art

Far infrared is one group in the infrared spectrum and is characterized by source temperatures from −50° C. to 420° C. and wavelengths from 4 micrometers to 14 micrometers. Far infrared radiation has strong transmission ability through the skin to subcutaneous tissue to activate and warm cells of our body from inside. Therefore, people wear cloth having far infrared radiation features to improve their body efficiency by accepting far infrared radiation all the time.

Far infrared cloth is made of a far infrared mineral with resin. The far infrared mineral is powdered to 5 mm particles and then mixed with resin to be spun into filaments of 10 mm diameter. The filaments are woven into far infrared cloth. However, based on the size of the filaments, the mineral particles inside the resin reduce the elongating efficiency of the filaments. Therefore, the filaments break easily during high-speed spinning, and the far infrared cloth is not endurable.

To overcome the shortcomings of the far infrared cloth, the present invention provides a method for making far infrared polymers to mitigate and/or obviate the aforementioned problems

### SUMMARY OF THE INVENTION

The main objective of the present invention is to provide a method of making far infrared polymers to make far infrared cloth more durable than conventional far infrared cloth.

Further benefits and advantages of the present invention will become apparent after a careful reading of the detailed description with appropriate reference to the accompanying drawings.

### BRIEF DESCRIPTION OF THE DRAWINGS

FIG. 1 is a schematic diagram of a method for making a far infrared membrane;

FIG. 2 is a diagram depicting the process of making particles in the method for making far infrared polymers;

FIG. 3 is a side plan view of a roller device for making far infrared filaments;

FIG. 4 is a side plan view of another roller device for making far infrared filaments;

FIG. 5 is a diagram depicting coating on an object with far infrared polymers;

FIG. 6 is a diagram depicting applying far infrared polymers to an isolating paper; and

FIG. 7 is a cross-sectional side plan view of a laminated cloth having a far infrared membrane.

### DETAILED DESCRIPTION OF THE INVENTION

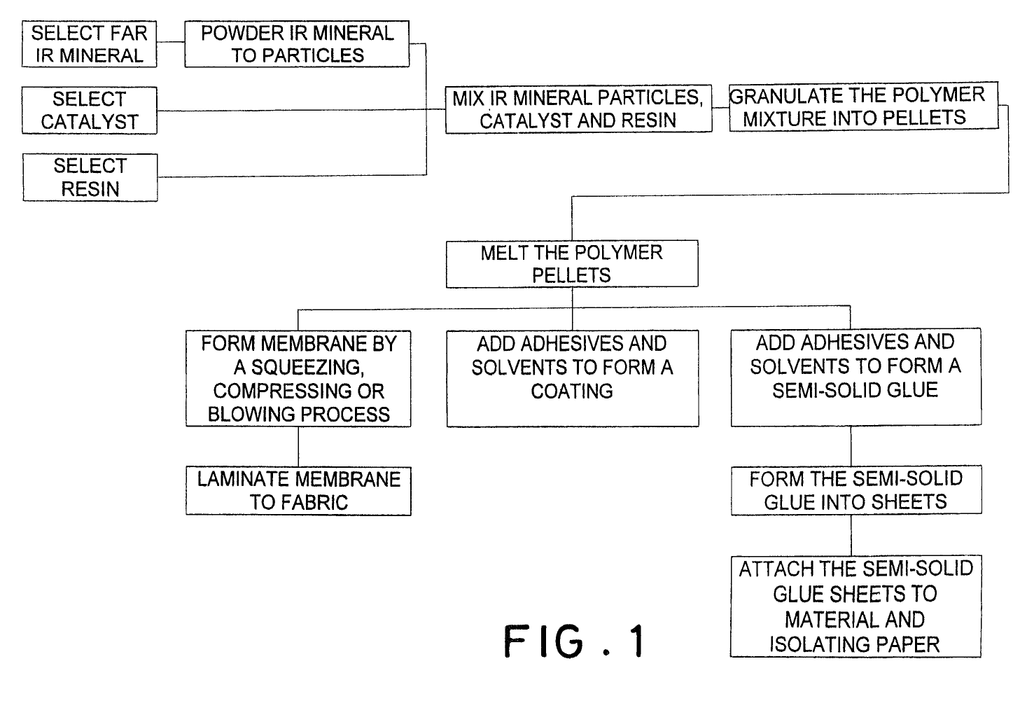

With reference to the drawings and initially to FIG. 1, a method for making far infrared polymer in membranes starts by preparing a far infrared mineral, a catalyst and a resin. The far infrared mineral is at least one mineral selected from the group comprising jade, crystal, homblende, serpentine, granite, dolomite or ceramics and powdered into tiny particles. The catalyst is at least one catalyst selected from the group comprising platinum photo-catalyst or titanium photo-catalyst. The resin is at least one selected from the group comprising thermoplastic polyurethane resin or nylon elastomer. Additionally, the far infrared laminated membrane is applied to multiple substrates to construct far infrared laminated membrane products.

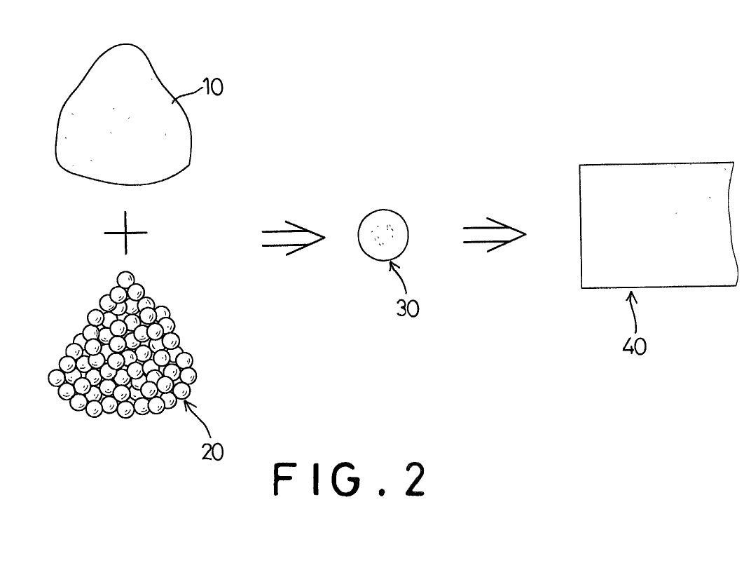

With reference to FIGS. 1 and 2, the far infrared mineral particles (10), the resin (20) and the catalyst (not shown) are mixed well with a mixer to form a polymer mixture, and the polymer mixture is granulated into polymer pellets (30). The far infrared mineral particles (10) are 0.3˜8% volume/volume (v/v) proportion of the polymer mixture and 3% (v/v) is the most preferred proportion option. The polymer pellets (30) are melted and shaped into a membrane (40) by a blowing, compressing or squeezing process. Then, the membrane (40) is attached to multiple desired substrates such as cloth by any one of the following means.

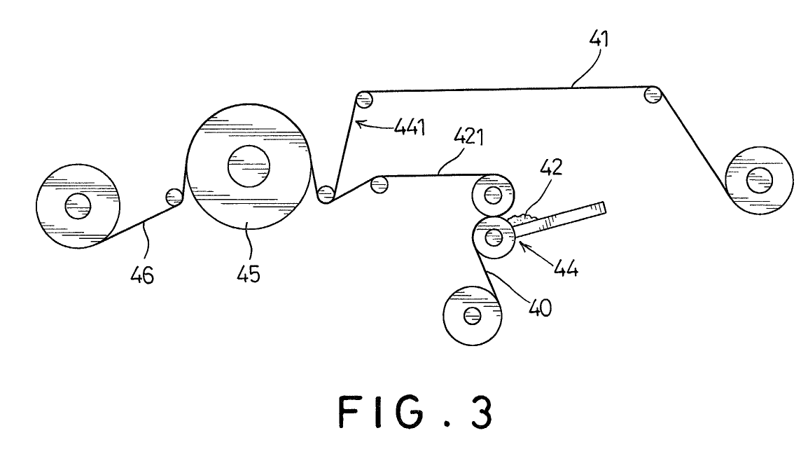

With reference to FIGS. 1 and 3, glue (42) is applied to the membrane (40) by a compressing device (44) to form a sticky membrane (421). Cloth (41) is delivered by a roller device (441) to a big roller (45) simultaneously with the sticky membrane (421) and is laminated to the sticky membrane (421). With the lamination of the cloth (41) and the sticky membrane (421), the far infrared cloth (46) is completed and is wound on a bolt (not numbered).

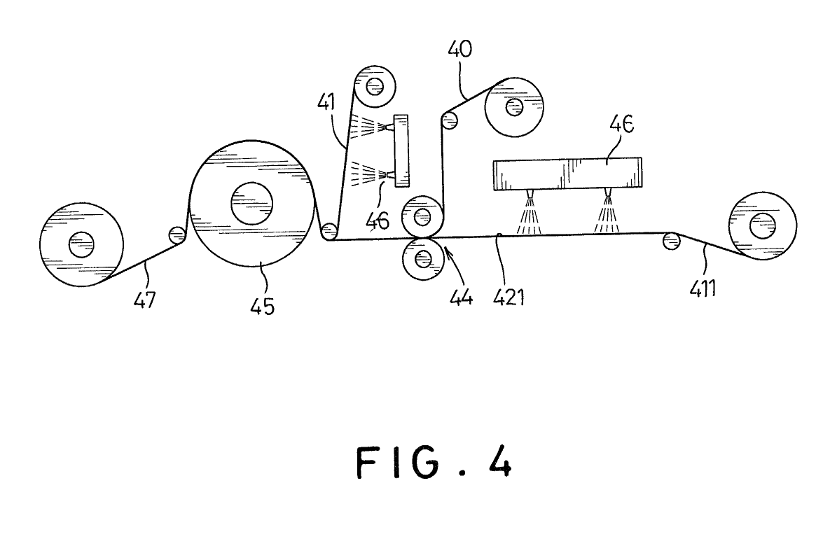

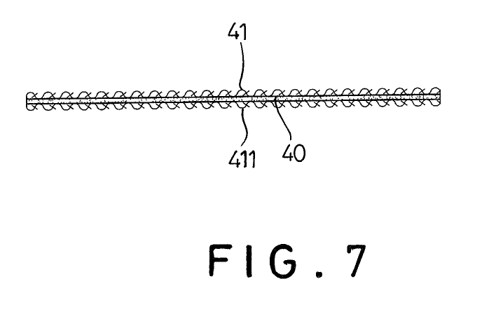

With reference to FIGS. 4 and 7, the membrane (40) is laminated between two layers of cloth (41, 411) with different properties. For example, the first layer of cloth (41) can be a tough outer fabric and the second layer of cloth (411) can be a delicate lining fabric. A glue sprayer (46) applies glue to a face of the second layer of cloth (411) that will contact the membrane (40) so the second layer of cloth (411) can be laminated on one side of the membrane (40) by the compressing device (44). Another glue sprayer (46) applies glue to a face of the first layer of cloth (41) that will contact the other side of the membrane (40) so the first layer of cloth (41) can be laminated on the other side of the membrane (40) by the big roller (45). Therefore, the far infrared cloth (47) is completed and has three layers (40, 41, 411).

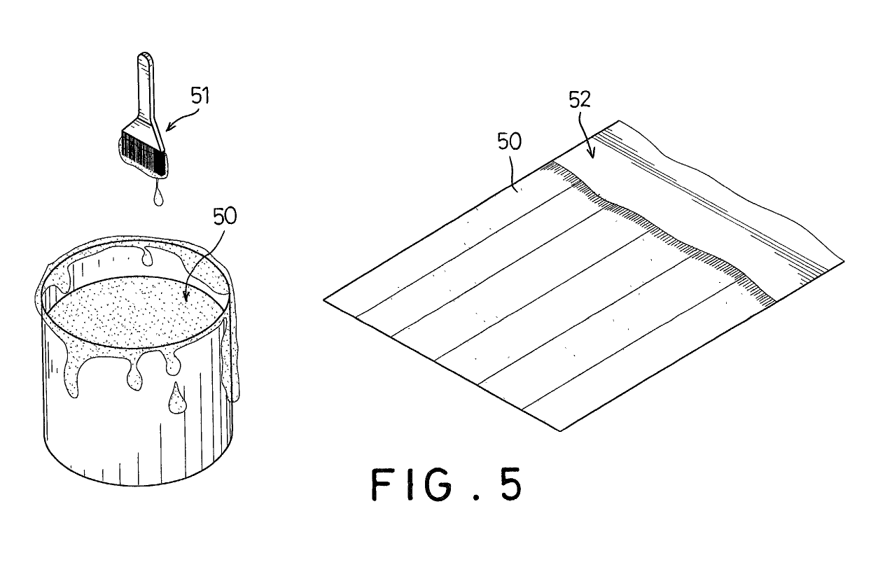

With reference to FIGS. 1 and 5, the polymer particles (30) may alternately be mixed with adhesives and solvents to form a far infrared coating (50). The far infrared coating (50) is applied to objects, such as wood (52) of a log cabin to make the cabin warm and waterproof or other things, needing far infrared properties by a brush (51).

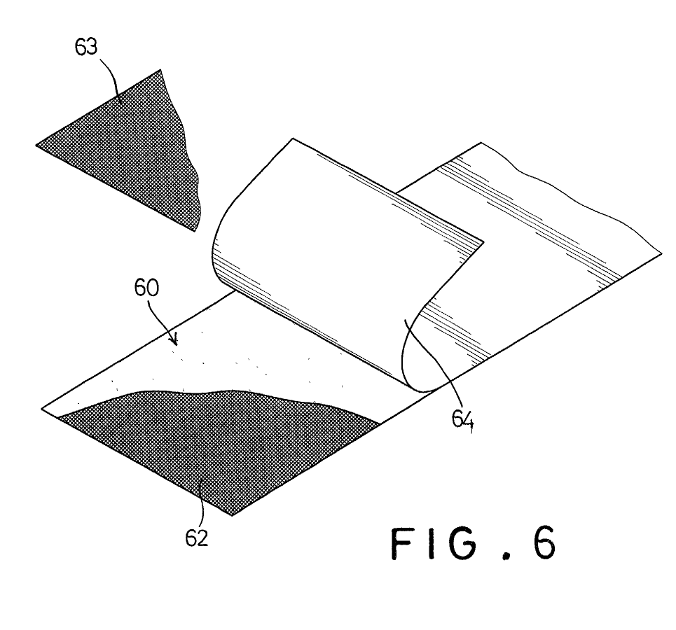

With reference to FIGS. 1 and 6, another embodiment of the far infrared polymer is far infrared semi-solid glue (60) that is applied to different materials (62) and covered by an isolating paper (64). In this form, the isolating paper (64) can be removed from the semi-solid far infrared glue (60) to conveniently attach the material to any possible object such as cloth, wood or metal floors, walls, stairs, etc.

Based on the foregoing description, several advantages of the method for making far infrared polymers include the following.

1. The far infrared membranes promotes the resonance of the water contained inside the membranes, therefore, water molecules are easily separated from the membranes to avoid damp.

2. The membrane contain resin, which has better resilient efficiency than other polymer to make the membranes have excellent elongating efficiency. The proportion of the far infrared mineral is proper to make the mineral particles enclosed by the resin, whereby the membranes are not easily broken and have multiple features such as excellent waterproofing, wind-proofing, heat retention and damp-proofing

3. The far infrared polymers in this invention have different embodiments for different applications such as laminated cloth, contact paper surface coating, etc. In these forms, far infrared properties can be used easily in our life.

Although the invention has been explained in relation to its preferred embodiment, it is to be understood that many other possible modifications and variations can be made without departing from the spirit and scope of the invention as hereinafter claimed.

What is claimed is:

1. A method for making far infrared polymers, the method comprising:
powdering an far infrared mineral into particles;
mixing the far infrared mineral particles, a catalyst and resin together to form a polymer mixture, wherein the far infrared mineral particles take 0.3˜8% volume/volume (v/v) proportion of the polymer mixture;
granulating the polymer mixture into polymer pellets;
melting the polymer pellets; and
forming a far infrared product.

2. The method as claimed in claim 1, wherein the far infrared mineral particles are 3% (v/v) proportion of the polymer mixture.

3. The method as claimed in claim 1, wherein the melted polymer pellets are compressed to produce a far infrared membrane.

4. The method as claimed in claim 1, wherein the melted polymer pellets are squeezed to produce a far infrared membrane.

5. The method as claimed in claim 1, wherein the melted polymer pellets are blown to produce a far infrared membrane.

6. The method as claimed in claim 1, wherein adhesives and solvents are added to the melted polymer pellets to form a far infrared coating.

7. The method as claimed in claim 1, wherein adhesives and solvents are added to the melted polymer pellets to form a semi-solid far infrared glue;
the semi-solid glue is formed into sheets;
the semi-solid glue sheets are attached to one surface of a material; and
the exposed semi-solid glue sheet is covered with an isolating paper.

8. The method as claimed in claim 1, wherein the far infrared mineral is at least one far infrared mineral selected from the group comprising jade, crystal, homblende, serpentine, granite, dolomite or ceramics.

9. The method as claimed in claim 1, wherein the catalyst is at least one catalyst selected from the group comprising platinum photo-catalyst or titanium photo-catalyst.

10. The method as claimed in claim 1, wherein the resin is at least one resin selected from the group comprising thermoplastic polyurethane resin or nylon elastomer.

11. A far infrared laminated membrane product comprising:
a membrane containing far infrared mineral powder, a catalyst, and a resin;
where at least one layer of substrate is laminated to at least one side of the membrane.

12. The far infrared laminated membrane product as claimed in claim 11, wherein the at least one substrate is cloth.

13. The far infrared laminated membrane product as claimed in claim 11, wherein the at least one substrate is isolating paper.
